(19) United States
(12) Patent Application Publication
(10) Pub. No.: US 2011/0084534 A1
(43) Pub. Date: Apr. 14, 2011

(54) HEADREST FOLDING STRUCTURE FOR A VEHICLE

(75) Inventor: In Tae SOHN, Incheon (KR)

(73) Assignee: WOOSUNG TECH CO., LTD, Incheon (KR)

(21) Appl. No.: 12/578,375

(22) Filed: Oct. 13, 2009

(51) Int. Cl. B60N 2/48; A47C 7/38

(52) U.S. Cl. 297/408; 297/391

(57) ABSTRACT

A fold type headrest includes a housing, a rotation support hinged on the housing, a stay rod mounted on the rotation support on the lower part of it and a cushion being attached on the upper part of it. The first spring elastically supports the rotation support or stay rod toward the folding direction, and a stopper is rotatably mounted on the housing and having an engaging paw to be engaged with the lower part of the stay rod. A second spring elastically supports the stopper toward the engaging position with the stay rod, and a releasing means is provided to disengage the stopper from the stay rod.

### BACKGROUND OF THE INVENTION

1. Field of the Invention

The invention relates to a headrest folding structure for a vehicle, and more particularly to a headrest folding structure for a vehicle with simple structure, cost reducing manufacturing, and easy manipulation.

2. Description of the Related Art

Usually, in case of RV vehicle or minibus which has three rows or more seats, the seat back of the rear seat is made to be folded to accommodate the baggage or to make the inner space used for various purposes. And the headrest of the rear seat is also made to be folded downward when the rear seat is folded.

The structure of the conventional foldable headrest is shown in FIGS. 1 and 2. As shown, the headrest comprises of a housing 10 installed on the seat back, a stay rod 22 engaged on the housing 10 by means of hinge member 23, a bracket 10a mounted in the housing 10, a holding member 30 and a brake member 40 rotatably engaged on the bracket 10a, and springs 35, 46, 50 which elastically support the stay rod 22, the holding member 30 and the brake member 40 respectively.

The housing 10 and the bracket 10a have guide recesses 12 and 17 respectively, and the holding member 30 has holding recess 32 and holding projection 34 to restrict the stay rod 22, and the brake member 40 has the braking projection 34 corresponding to the holding projection 34, and the actuating wire 40b on one end.

According to the structure mentioned above, in the state that the holding projection 34 and the braking projection 43 are engaged as shown in FIG. 2, the rotational position of the holding member 30 is restricted by the braking projection 40, and the stay rod 22 is restricted in the holding recess 32 of the holding member 30, so that headrest 20 is kept in the upright state.

In that state, if the lever is actuated to pull the actuating wire 40b, the brake member 40 is rotated, and then the holding member 30 is disengaged from the braking member 40 and is rotatable, so that the stay rod 22 is released from the holding projection 32 by the force of spring 52, and the headrest 20 is folded forward.

But, this conventional foldable headrest has relatively complicated structure because it has holding member 30 to restrict the rotation of stay rod 22, and the brake member 40 to restrict the rotation of the holding member 30, which results in high cost and low productability. Moreover, as the holding member 30 is actuated by the lever disposed at the lower part of the rear side of seat back and connected to the wire 40b, the manipulation of it by the person inside the inner cabin is relatively difficult because he or she cannot access the lever easily.

And, the conventional headrest has only two modes of upright and forwardly horizontal position, so the headrest cannot be folded backward or positioned in proper angle according to the passenger's pose.

### SUMMARY OF THE INVENTION

The invention is provided to solve the above mentioned problems, and the object of the invention is to provide a fold type headrest having simple structure with low cost and high productability.

Another object of the invention is to provide a fold type headrest to be easily manipulated by the passenger inside the cabin.

Another object of the invention is to provide a fold type headrest which can be folded backward as well as forward, and positioned in a proper angle to meet the passenger's various poses.

According to one aspect of the invention, there is provided a fold type headrest comprising of a housing installed on the seat back of rear seat, a rotation support hinged on the housing on both side of it, a stay rod mounted on the rotation support on the lower part of it and a cushion being attached on the upper part of it, a first spring elastically supporting the rotation support or stay rod toward the folding direction, a stopper rotatably mounted on the housing and having an engaging paw to be engaged with the lower part of the stay rod, a second spring elastically supporting the stopper toward the engaging position with the stay rod, and a releasing means to disengage the stopper from the stay rod.

According to one aspect of the invention, there is provided a fold type headrest wherein the release means is an actuating rod connected to the stopper at the lower end and extending above the seat back and exerting the rotating force to the stopper by up and down movement.

According to another aspect of the invention, there is provided with a folding type headrest wherein the stopper has a plurality of engaging paws along the rotating path of the lower part of the stay rod to stop the stay rod at a proper angle.

According to the invention as described above, the stay rod can be hold in a folded position by direct engagement with the stopper, so the folding structure can be made with simple structure and a fewer parts to achieve low cost and high productability.

And as the release means comprises an actuating rod which is projecting above the seat back in addition to the wire-linked lever disposed on the lower part of the rear side of the seat back, the passenger can manipulate the folding headrest easily in the cabin.

And as the stay rod is rotatable forward and backward against the housing, and the stopper has a plurality of engaging paws to stop the stay rod at a proper angle, he headrest can be adjusted in a various angle to support the passenger's head more comfortable.

### BRIEF DESCRIPTION OF THE DRAWINGS

The above and other objects or advantages of the invention will become more apparent by describing the preferred embodiments thereof in detail with reference to the accompanying drawings in which:

FIG. 1 is an exploded view of the conventional fold type headrest.

FIG. 2 is a side view of the conventional fold type headrest.

FIG. 3 is an exploded view of the embodiment of the invention.

FIG. 4 is a perspective of the embodiment of the invention.

FIGS. 5 and 6 are sections of the embodiment of the invention in upright and folded states.

FIG. 7 is a side view of another embodiment of the invention.

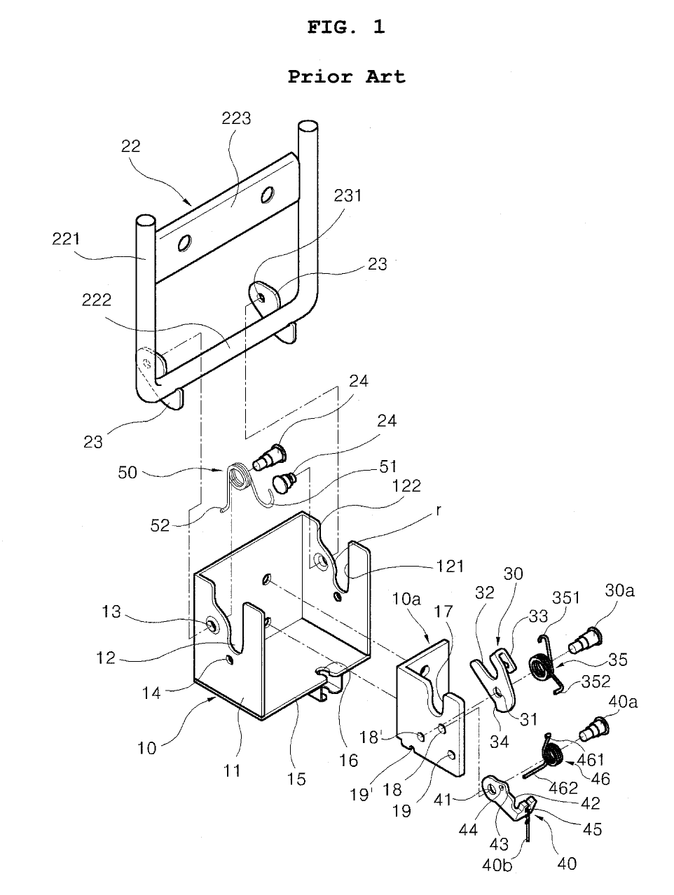

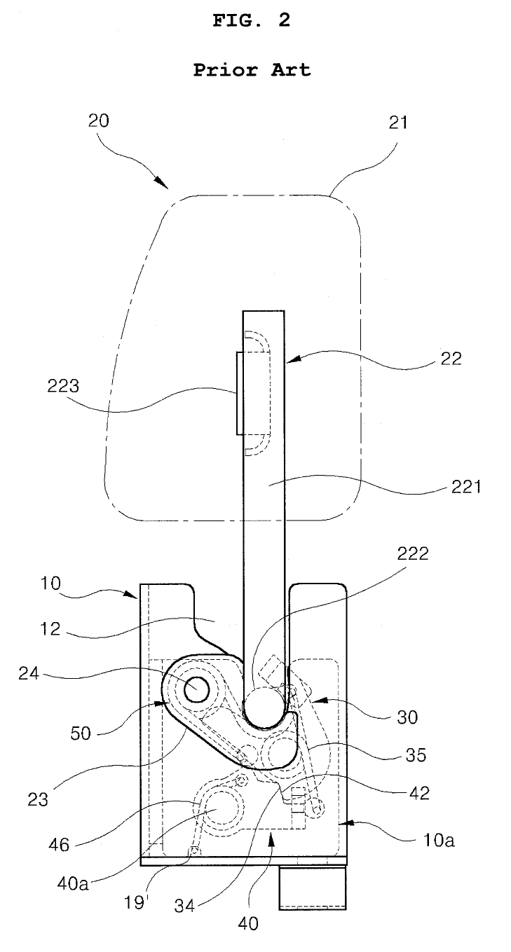

### DETAILED DESCRIPTION OF THE PREFERRED EMBODIMENTS

Herein below, the preferred embodiment of the invention will be described with reference to the accompanying drawings.

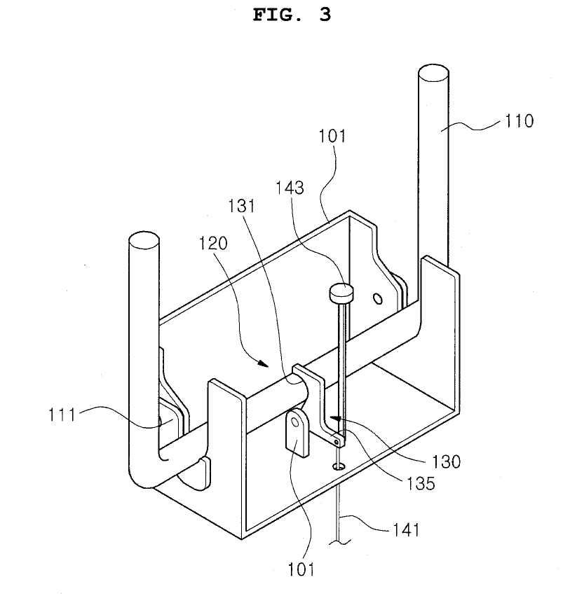

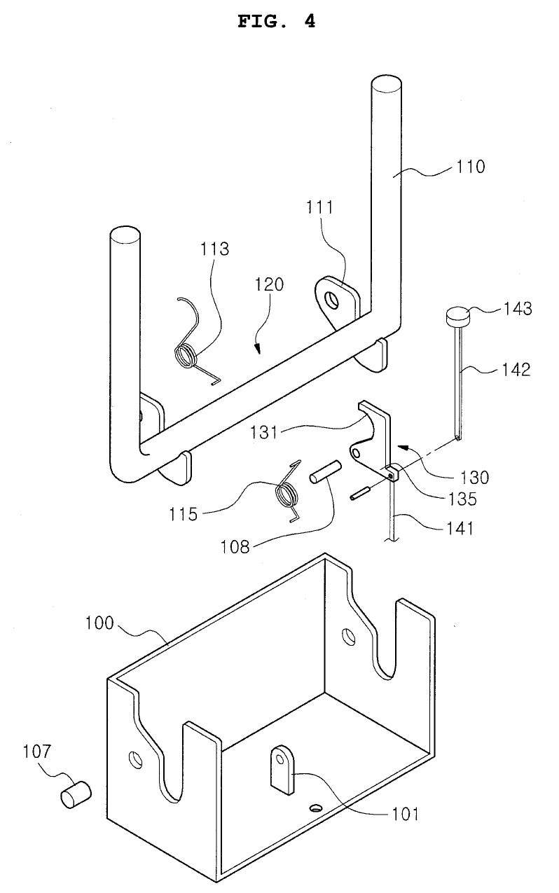

FIGS. 3 and 4 shows the embodiment of the invention in exploded view and assembled view respectively. As shown, the headrest comprises of housing 100 installed on the seat back of the rear seat, a rotation support 111 hinged on the housing 100 on both side of it, a stay rod 110 having U shape and the lower part of it being mounted on the rotation support 111 and a cushion 10 being attached on the upper part of it, a stopper 130 rotatably mounted on the housing 100 and to engage and disengage with the stay rod 110, a first spring 113 elastically supporting the stay rod 110 so that the front end of the stay rod 110 is directed toward the folding position, a second spring 115 elastically supporting the stopper 130 to be engaged with the stay rod 110, and a release means to rotate and disengage the stopper 130 from the stay rod 110.

The rotation supports 111 are hinged on the housing 110 by means of the first hinge shaft 107, and the stay rod 110 is distanced from the first hinge shaft 107 so that the stay rod 110 is located on the eccentric position against the rotational center of the rotational support 111.

The stopper 130 is hinged on the bracket 101 mounted on the hosing 100 by means of the second hinge shaft 108. An engaging paw 121 is provided on the upper part of the stopper 130 and a connecting part 135 is formed on the lower part of the stopper 130 to be connected with the release means. The upper part of the engaging paw 121 is formed in round or inclined shape so that, when the stay rod 110 is returned, it can slide on the upper part of the engaging paw 121 to be engaged smoothly.

The first spring 113 and the second spring 115 may be adopted as various proper types such as a type coil spring, leaf spring, spiral coil spring.

The release means includes a lever (not shown) disposed on the rear side of the seat back and connected to the wire 141 at the connecting part 135, and the actuating rod 142 hinged on the connecting part 135 and extending above the sate back, and a push button 143 on top of the actuating rod 142.

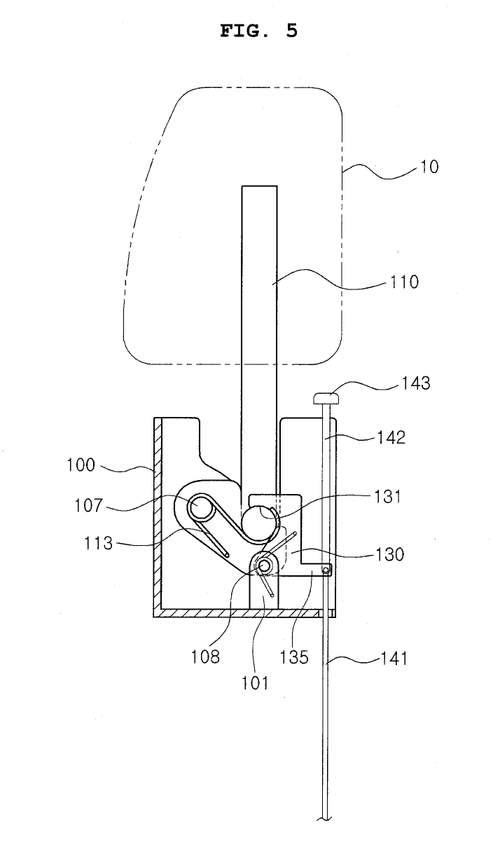

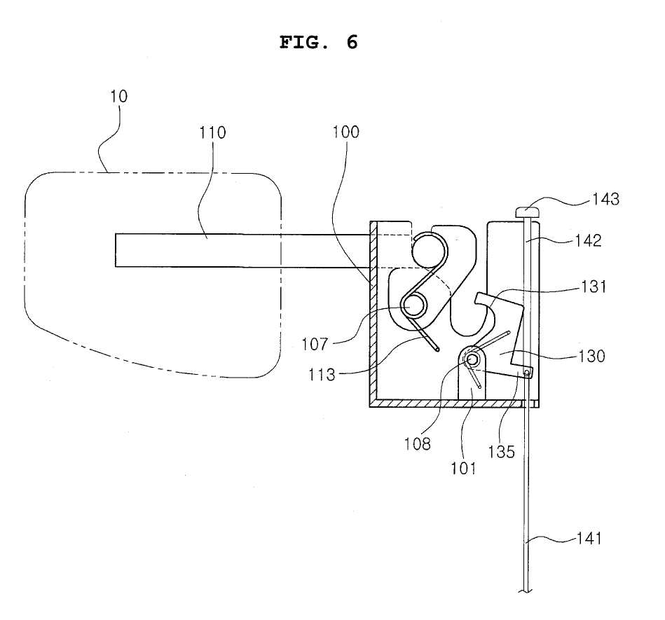

The folding operation of the invention is described herein after. As shown in FIG. 5, the stopper 130 is engaged with the lower part of the stay rod 110 by force of the second spring 115 and the stay rod 110 is kept in upright state. If the user pulls the lever or pushes down the actuating rod 142, the stopper 130 then rotated clockwise and the engaging paw 131 of the stopper 130 is disengaged from the stay rod 110. Then the stay rod 110 rotated counterclockwise by force of the first spring 113, so that the headrest may be folded horizontally as shown in FIG. 6.

In the user pushes cushion 10 to return the headrest 10 into the original position, the stay rod 110 may be rotated reversely and the lower part of the stay rod 110 may be engaged with the stopper 130 at the upright position as shown in FIG. 5.

The folding structure of the headrest according to invention is constructed for the stopper 130 to be engaged and disengaged with the stay rod 10 directly, so the parts number may be reduced which results in the lower cost and high productability. And, as the release means includes a actuating rod 142 extending above the seat back in addition to the ordinary lever connected to the wire 141 and positioned on the rear side of the seat back, the passenger can operate the folding headrest in the cabin more easily.

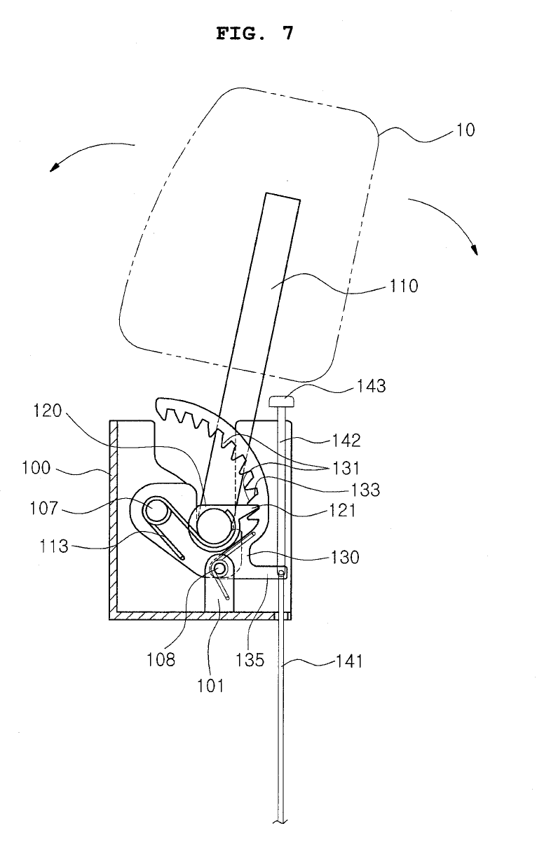

FIG. 7 shows another embodiment of the invention. In this embodiment, the stay rod 110 is hinged on the housing 100 so that the stay rod 110 can rotated forward and backward, and a claw 121 is attached on the lower part of the stay rod 110. And a plurality of engaging paws 131 are formed on the stopper 130 along the rotating path of the lower part of the stay rod 110. The claw 121 of the stay rod 110 can engaged with any of the engaging paws 131 of the stopper 130. According to this embodiment, the stay rod 130 may be set at a various angular position so that the passenger may rest his head on the headrest cushion at any convenient angle depending on his pose.

What is claimed is:

1. A fold type headrest comprising of a housing installed on the seat back of rear seat, a rotation support hinged on the housing on both side of it, a stay rod mounted on the rotation support on the lower part of it and a cushion being attached on the upper part of it, a first spring elastically supporting the rotation support or stay rod toward the folding direction, a stopper rotatably mounted on the housing and having an engaging paw to be engaged with the lower part of the stay rod, a second spring elastically supporting the stopper toward the engaging position with the stay rod, and a releasing means to disengage the stopper from the stay rod.

2. A fold type headrest according to claim 1, wherein the release means is an actuating rod connected to the stopper at the lower end and extending above the seat back and exerting the rotating force to the stopper by up and down movement.

3. A fold type headrest according to claim 1, wherein the stopper has a plurality of engaging paws to stop the stay rod at a proper angle.

4. A fold type headrest according to claim 2, wherein the stopper has a plurality of engaging paws to stop the stay rod at a proper angle.
